(19) United States
(12) Patent Application Publication
(10) Pub. No.: US 2007/0217122 A1
(43) Pub. Date: Sep. 20, 2007

(54) Capacitor

(75) Inventors: Spartak Gevorgian, Gothenburg (SE); Thomas Lewin, Onsala (SE); Herbert Zirath, Molndal (SE); Bahar Motlagh, Gothenburg (SE)

Correspondence Address: POTOMAC PATENT GROUP, PLLC, P. O. BOX 270, FREDERICKSBURG, VA, 22404, US

(73) Assignee: TELEFONAKTIEBOLAGET LM ERICSSON (PUBL), Stockholm (SE)

(21) Appl. No.: 10/596,664

(22) PCT Filed: Dec. 23, 2003
(86) PCT No.: PCT/SE03/02068

§ 371 Date: May 24, 2007

(51) Int. Cl. H01G 4/232

(52) U.S. Cl. 361/307; 29/25.41

(57) ABSTRACT

A method of creating a capacitor in an integrated circuit. According to a basic version of the invention the capacitor uses intensive fringing fields to create a capacitance. This is achieved by creating a capacitor with vertical overlapping conducting electrodes between two planes of the integrated circuit, instead of plates parallel to the planes. A capacitor according to the invention can additionally comprise horizontal, i.e. parallel plates. A capacitor according the method is also disclosed.

### TECHNICAL FIELD

The invention concerns capacitors, especially capacitors, resonators and filters in sub-micrometer CMOS technology integrated circuits and is more particularly directed to a method of creating a high capacitance per unit area of a silicon chip, and capacitors, resonators, filters and transmission lines implementing the method.

### BACKGROUND

There is a desire to be able to use integrated circuits for high frequency circuits, in the microwave range and higher. The desire to increase speed/frequency necessitates decreased size features, presently gate lengths well below 1.0 μm, in CMOS and related technologies. This results in a drastic increase in price per unit area, i.e. $/square mm, of the silicon chips.

There have been attempts to use high integration density, low cost standard silicon technology such as CMOS and bipolar. Such silicon technology has a low resistivity, less than 10-20 Ohm cm. To use such silicon for fabrication of microwave integrated circuits, for example high-speed digital integrated circuits, there will be high losses in passive components associated with the low resistivity silicon substrate. Passive components can for example be transmission lines, interconnections, inductors, and capacitors.

Traditionally two different types of on-chip capacitors have been used in standard silicon technology. A first type, Metal-Insulator-Metal (MIM) capacitors used in standard silicon integrated circuits have high losses and a low self-resonant frequency due to the small thickness and low conductivity of the capacitor plates. MIM capacitors could also be argued to have reliability problems. A second type, Metal-Insulator-Metal-Insulator-Metal (MIMIM) capacitors have similar disadvantages. There seems to be room for improvement of how to implement capacitors in an integrated circuit, such as CMOS or bipolar, especially in low resistivity integrated circuits.

### SUMMARY

An object of the invention is to define a method of creating a capacitor and to define a capacitor which overcome the above mentioned drawbacks.

Another object of the invention is to define a method of creating a capacitor and to define a capacitor, which requires a minimal unit area.

A further object of the invention is to define a method of creating passive components, such as transmission lines and to define passive components, such as transmission lines with low losses.

The aforementioned objects are achieved according to the invention by a method of creating a capacitor in an integrated circuit. According to a basic version of the invention the capacitor uses intensive fringing fields to create a capacitance. This is achieved by creating a capacitor with vertical overlapping conducting electrodes between two planes of the integrated circuit, instead of plates parallel to the planes. A capacitor according to the invention can additionally comprise horizontal, i.e. parallel plates. A capacitor according the method is also disclosed.

The aforementioned objects are also achieved by a method of arranging an on-chip capacitor. The on-chip capacitor creates a capacitance between a first conducting connection point in a first plane of the chip and a second conducting connection point in a second plane of the chip. According to the invention the method comprises creating at least one conducting extension of a first type from the first conducting point towards the second plane to a third plane. Extensions of the first type always originate at the first plane and extend towards the second plane. The method further comprises creating at least one conducting extension of a second type from the second conducting connection point towards the first plane to a fourth plane. Extensions of the second type always originate at the second plane and extend towards the first plane. The fourth plane is located between the first plane and the second plane. The third plane is located between the fourth plane and the second plane. The first conducting extension is isolated from the second conducting extension by a dielectric allowing an electrical field to be created between the extensions. The conducting extensions thus overlap and are suitably close together, but at a distance so that there is no flash-over or breakdown of the dielectric. Suitably the extensions of the first and of the second type extend in principal parallel to a normal of the plane that they extend from.

Suitably the method further comprises creating a plurality conducting extensions of the first type and/or of the second type. In these cases the first and second conducting points respectively as applicable would take the form of a conducting area. Sometimes the first plane is a side of a first metal layer, and the second plane is a side of a second metal layer, the first and the second metal layers being different metal layers. In some versions the third and fourth planes are different sides of a third metal layer. In other versions the third plane is a side of a third metal layer and the fourth plane is a side of a fourth metal layer, the third and the fourth metal layers being different metal layers.

In some versions of the method, the method further comprises originating the conducting extension or extensions of the first and/or second type in a metal layer and terminating the conducting extension or extensions of the first and/or second type in a metal layer. In these version it can sometimes be appropriate that the method further comprises extending conducting extension or extensions of the first type through at least one further metal layer. To increase the capacitance of the capacitor the method can suitably further comprise extending the first conducting connection point in the first plane of the chip to comprise a conducting plate and/or comprise extending the second conducting connection point in the second plane of the chip to comprise a conducting plate.

The conducting extensions are suitably manufactured as vias, either solid or hollow.

One or more of the features of the above-described different methods according to the invention can be combined in any desired manner, as long as the features are not contradictory.

The aforementioned objects are also achieved by a method of creating an on-chip resonant circuit. The method comprises arranging one or more capacitors according to any one of the above-described methods, and at least one other passive component to thereby create the resonant circuit.

The aforementioned objects are also achieved by a method of creating an on-chip transmission line. The method comprises arranging one or more capacitors according to any one of the above-described methods, in the transmission line.

The aforementioned objects are also achieved according to the invention by an on-chip capacitor with a capacitance between a first conducting connection point in a first plane of the chip and a second conducting connection point in a second plane of the chip. According to the invention the on-chip capacitor comprises at least one conducting extension of a first type from the first conducting point towards the second plane to a third plane. Extensions of the first type always originate at the first plane and extend towards the second plane. The on-chip capacitor further comprises at least one conducting extension of a second type from the second conducting connection point towards the first plane to a fourth plane. Extensions of the second type always originate at the second plane and extend towards the first plane. The fourth plane is located between the first plane and the second plane. The third plane is located between the fourth plane and the second plane. The first conducting extension is isolated from the second conducting extension by a dielectric allowing an electrical field to be created between the extensions. Suitably the extensions of the first and of the second type extend in principal parallel to a normal of the plane that they extend from.

The on-chip capacitor can suitably further comprise a plurality of conducting extensions of the first and/or the second type. In these cases the first and second conducting points respectively as applicable would take the form of a conducting area. The first plane can be a side of a first metal layer, and the second plane can be a side of a second metal layer, the first and the second metal layers being different metal layers. The third and fourth planes can be different sides of a third metal layer in some embodiments. In other embodiments the third plane can be a side of a third metal layer and the fourth plane can be a side of a fourth metal layer, the third and the fourth metal layers being different metal layers.

The conducting extension or extensions of the first and or the second type can suitably in some embodiments originate in a metal layer and terminate in a metal layer. In some of these embodiments the conducting extension or extensions of the first and/or the second type suitably extends through at least one further metal layer.

The first conducting connection point in the first plane of the chip can in some embodiments comprise a conducting plate. The second conducting connection point in the second plane of the chip can in the same or other embodiments comprise a conducting plate.

The conducting extensions are suitably vias, either solid or hollow.

The features of the above-described different embodiments of an on-chip capacitor according to the invention can be combined in any desired manner, as long as no conflict occurs.

The aforementioned objects are also achieved according to the invention by an on-chip resonant circuit, where the resonant circuit comprises one or more capacitors according to any one of the above-described embodiments.

The aforementioned objects are also achieved according to the invention by an on-chip transmission line, where the transmission line comprises one or more capacitors according to any one of the above-described embodiments.

The aforementioned objects are also achieved according to the invention by a transmission line based component such as a resonator, matching network, or power splitter, where the transmission line based component comprises a transmission line according to any one of the above described embodiments.

By providing a method of creating an on-chip capacitor, a transmission line, and other passive components and embodiments thereof according to the invention a plurality of advantages over prior art methods and components are obtained. Primary purposes of the invention are to propose new designs of high density and Q-factor capacitors, resonators, and related microwave components compatible with sub-micrometer CMOS and bipolar silicon processes. According to the invention this is enabled primarily by making use of vias in multilayer silicon processes to generate intensive fringing fields between the vias and optional plates of the capacitors and thus increase the capacitance per unit area. Other advantages of this invention will become apparent from the description.

### BRIEF DESCRIPTION OF THE DRAWINGS

The invention will now be described in more detail for explanatory, and in no sense limiting, purposes, with reference to the following figures, in which

FIG. 1A illustrates an example of a plate capacitor,

FIG. 1B illustrates a MIM (Metal-Insulator-Metal) integrated plate capacitor,

FIG. 1C illustrates a MIMIM (Metal-Insulator-Metal-Insulator-Metal) integrated plate capacitor,

FIG. 2 illustrates a top view of an interdigitated capacitor layout,

FIG. 3A illustrates a side view of a basic embodiment of a capacitor structure according to the invention,

FIG. 3B illustrates a side view of a preferred basic embodiment of a capacitor structure according to the invention,

FIG. 3C illustrates a cross section view across A-A of FIG. 3B of a capacitor structure according to the invention,

FIG. 3D illustrates a three-dimensional view of a preferred basic embodiment of a capacitor structure according to the invention,

FIG. 3E illustrates a cross section view of an alternative form of the conductive extensions,

FIG. 4A illustrates a side view of a preferred basic capacitor structure according to the invention in a three metal layer chip structure,

FIG. 4B illustrates a cross section view along the middle metal layer of FIG. 4A,

FIG. 4C illustrates a side view of a capacitor structure according to the invention in a four metal layer chip structure,

FIG. 5A illustrates a side view of a more complex capacitor structure according to the invention in a four metal layer chip structure,

FIG. 5B-5D illustrate cross section views along one of the middle metal layers of FIG. 5A showing different layout examples of the conductive extensions,

FIG. 6A-6B illustrate further cross section views of different layout examples of the conductive extensions,

FIG. 7A-7B illustrate an example of a resonant circuit in a structure according to the invention,

FIG. 8 illustrates a transmission line structure according to the invention.

### DETAILED DESCRIPTION

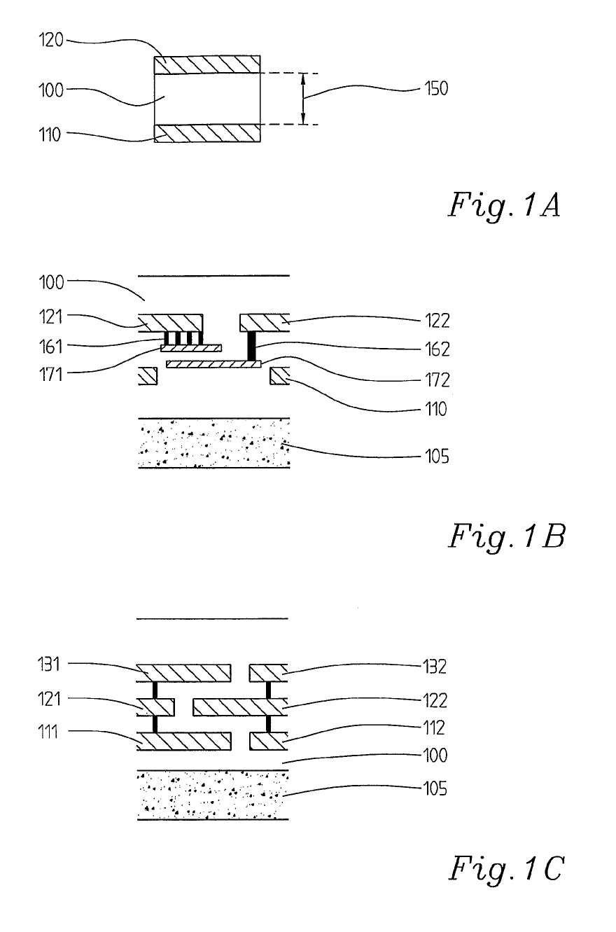

In order to clarify the method and device according to the invention, some examples of its use will now be described in connection with FIGS. 1 to 8.

FIG. 1A illustrates an example of a plate capacitor comprising a first plate 110 and a second plate 120. The plates 110, 120 are at a set distance 150 apart. The space between the plates 110, 120 comprises a dielectric 100, which can be a gas such as air, vacuum, or a solid material. The capacitance between the plates is given by the area of the plates 110, 120, the distance 150 between the plates 110, 120, and the dielectric 100 in the space between the plates 110, 120.

As mentioned above, there are several methods of creating an on-chip capacitance. FIG. 1B illustrates a MIM (Metal-Insulator-Metal) integrated plate capacitor. An on-chip capacitor is created on a silicon wafer 105, upon which several metal layers 110, 121,122 are built with a dielectric 100 in-between. A MIM type capacitor comprises two 171, 172 specially made thin metal plates, between which a capacitance is created. Each special metal plate 171, 172 comprises vias 161, 162 to the corresponding ordinary metal layer parts 121, 122. A further type of on-chip capacitor is illustrated in FIG. 1C. FIG. 1C illustrates a MIMIM (Metal-Insulator-Metal-Insulator-Metal) integrated plate capacitor. A MIMIM integrated plate capacitor does not require special metal plates as a MIM does. A MIMIM type capacitor utilizes the ordinary metal layers 111, 112, 121, 122, 131, 132 to create the plates with a dielectric 100 in-between on top of a silicon wafer 105. A MIMIM also suffers from the necessity of a relatively large unit area for a desired capacitance.

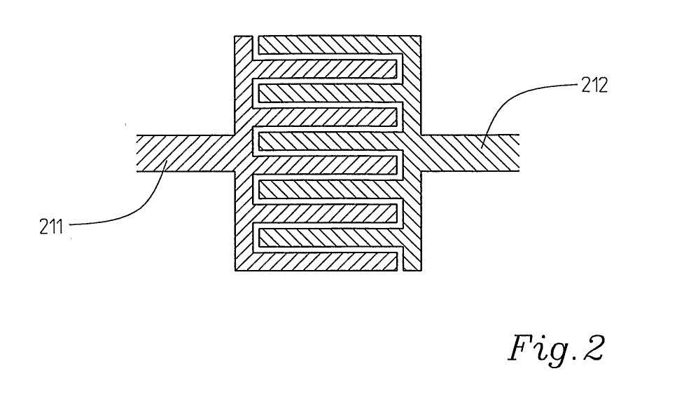

A radically different type of capacitor has been suggested where the capacitor plates are arranged adjacent in a same plane instead of on top of each other. FIG. 2 illustrates a top view of such a capacitor, an interdigitated capacitor layout, which comprises a first part of a metal layer 211 and a second part of the same metal layer 212. The capacitance is in part achieved by the thickness of the plates/fingers creating miniature plates close together, and by fringing fields between the plates/fingers. This type of capacitor has the advantage that it can be built in one single metal layer, but it requires a relatively large surface area.

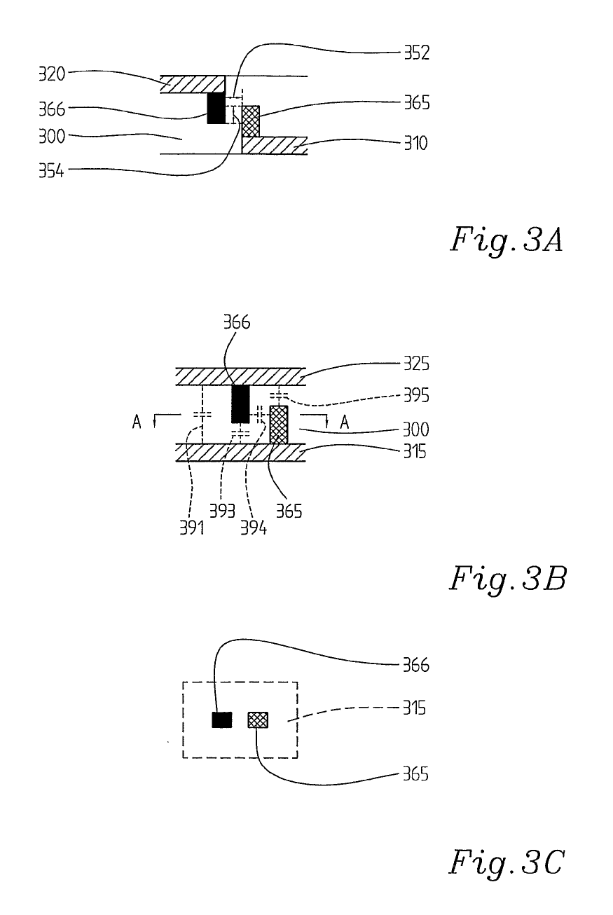

The present invention creates an optimum capacitance in a limited surface area. This is achieved by using a depth of a structure in which a capacitor is created to create surfaces between which fields can be created. FIG. 3A illustrates a side view of a basic embodiment of a capacitor structure according to the invention. The basic embodiment is illustrated by a simple chip structure comprising a first metal layer 310, which at least in part creates a first conducting point in a first plane, a second metal layer 320, which at least in part creates a second conducting point in a second plane. The first 310 and second 320 metal layers are separated by a dielectric 300. According to the invention the capacitor structure comprises at least one of a first type of conducting extension 365 that extends from the first conducting point 320 towards the second plane and at least one of a second type of conducting extension 366 that extends from the second conducting point 310 towards the first plane. The conducting extensions 365, 366 are separated a distance 352 and overlap a distance 354 along the extensions. According to the invention a capacitance is created between the conducting extensions 365, 366 that extend substantially perpendicular to the planes of the metal layers 310, 320. The larger cross sectional area the extensions have, the longer the overlap along the extensions, the closer the extensions are to each other, the higher the resulting capacitance as seen between the first and second conducting points is.

Instead of just having first and second conducting points 310, 320, it is advantageous to let the metal layers form conducting plates that contribute to the capacitance. FIG. 3B illustrates a side view of a preferred basic embodiment of a capacitor structure according to the invention with further capacitor plates/conducting plates 315, 325 in addition to the conductive extensions 365, 366. The capacitance attained will, as previously explained, be dependent on the dielectric 300, the effective area of the capacitor plates, and the effective distance between them. According to the invention the conductive extensions 365, 366 create capacitor plates extending into the chip structure. The attained effective capacitor plate area attained from the conductive extensions 365, 366 will depend on the geometry of the extensions and the amount of overlap 354. As seen in FIG. 3B the total capacitance attained will primarily be attained by a combination of a capacitive coupling 391 between the first and second conducting plates 315, 325, a capacitive coupling 393 between the second type of conducting extension 366 and the first conducting plate 315, a capacitive coupling 394 between the first 365 and second 366 types of conducting extensions, and a capacitive coupling 395 between the first type of conducting extension 365 and the second conducting plate 325.

FIG. 3C illustrates a cross section view across A-A of FIG. 3B of a capacitor structure according to the invention where a first example of a cross section of a first 365 and second 366 conducting extensions are shown above a first conducting plate 315. The invention is not dependent upon or limited to any special type of cross section or cross sectional area, the first and second type of conducting extensions do not even have to have the same type of cross section, or cross sectional area. FIG. 3D illustrates a three-dimensional view of a preferred basic embodiment of a capacitor structure according to the invention with a first 315 and a second 325 conducting plate, a first 365 and a second 366 type of conducting extension. FIG. 3E illustrates a cross section view of an alternative form of the conductive extensions 365, 366 above a first 315 conducting plate.

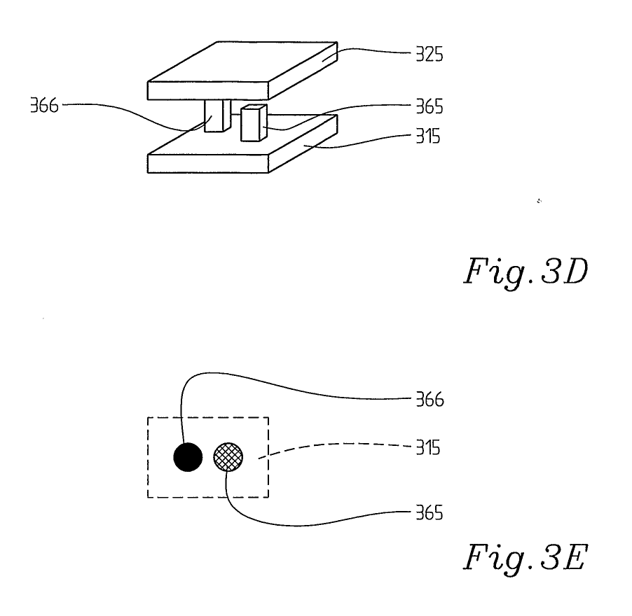

Manufacturing conducting extensions between two metal layers of an integrated circuit is difficult and therefore expensive and not usually the preferred method of executing the invention. A preferred method of manufacturing the invention is to make the conducting extensions in the form of vias. The vias can be filled, i.e. solid, or hollow, i.e. in the form of a conducting tubes. FIG. 4A illustrates a side view of a preferred basic capacitor structure according to the invention in a three metal layer chip structure. This compact structure comprises a dielectric 400 between a first metal layer 416 comprising a first conducting plate, parts acting as terminations of vias of a second metal layer 426, 427, and a third metal layer 436 comprising a second conducting plate. The first and second types of conducting extensions are thus at least in part vias between metal layers. In this example a first type of conducting extension will comprise a via 465 between the first 416 and second 426 metal layers and a part of the second 426 metal layer where the via 465 is terminated. A second type of conducting extension will comprise a via 466 between the second 426 and third 436 metal layers and a part of the second 427 metal layer where the via 466 is terminated. In this example the capacitance is mainly attained by a capacitive coupling 491 between the first 416 and second 436 conducting plates, a capacitive coupling 493 between the second metal layer 427 of the second conducting extension and first conducting plate 416, a capacitive coupling 494 between first and second conductive extensions in the overlap area, in this example in the second metal 426, 427 layer where the vias of the first and second conductive extensions are terminated, and a capacitive coupling 495 between the second 426 metal layer of the first conducting extension and the second conducting plate 436.

FIG. 4B illustrates a cross section view along the middle metal layer of FIG. 4A where the second metal layer part 426 of the first conductive extension, the second metal layer part 427 of the second conductive extension, the via part 465 of the first conductive extension, and the via part 466 of the second conductive extension shows.

The invention is not restricted to the number of metal layers a chip structure comprises. FIG. 4C illustrates a side view of a capacitor structure according to the invention in a four metal layer chip structure. As before, the structure comprises a first metal layer 418, intermediate metal layers, in this example a second 428, 429 and a third metal layer, and a final, fourth metal layer 448, and a dielectric 400 in between these metal layers. Advantageously the first metal layer 418 and the final metal layer, the fourth metal layer 448, in addition to providing conducting points for capacitor connection, also comprise conducting plates to add capacitance. In this example a first type of conducting extension will comprise a first via 465 between the first 418 and second 428 metal layers, a part of the second 428 metal layer where the first via 465 is terminated, a second via 467 between the second 428 and third 438 metal layers, and a part of the third 438 metal layer where the second via 467 is terminated. A second type of conducting extension will comprise a first via 466 between the third 439 and fourth 448 metal layers, a part of the third 439 metal layer where the first via 466 is terminated, second via 468 between the second 429 and third 439 metal layers, and a part of the fourth 439 metal layer where the second via 468 is terminated. By the introduction of another metal layer, the overlap of the conductive extensions of the first and second type increases to comprise the second 428, 429 and third 438, 439 metal layers as well as the second vias 467, 468. This will dramatically increase the efficiency of the capacitor.

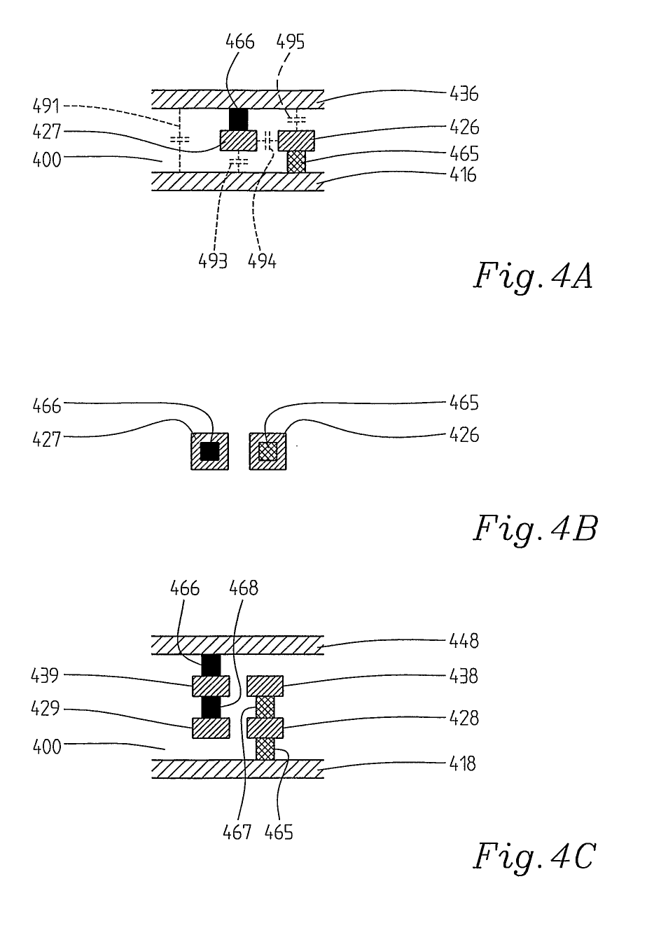

As previously described, the invention is not limited to any particular number of conductive extensions of the first and/or the second type. FIG. 5A illustrates a side view of a more complex capacitor structure according to the invention in a four metal layer chip structure. The structure is similar to that of FIG. 4C with four metal layers 511, 521, 522, 531, 532, 541, vias 561, 562, 572, 573 and a dielectric 500 as filling. However, the structure illustrated in FIG. 5A uses a plurality of the first and second type of conductive extensions.

Depending on where the side view of FIG. 5A is located, it can represent many different capacitor layouts. The conductive extensions of the first and second types can be evenly distributed, placed in rows, placed in circles or any desirable configuration. Differences in layout can for example be due to screening purposes or space restrictions. FIGS. 5B to 5D illustrate cross section views along one of the middle metal layers of FIG. 5A showing different layout examples of the conductive extensions. To be able to identify the layouts properly the FIGS. 5B to 5D show first via parts of a first type of conductive extension 561, the corresponding second metal layer 521 part acting as intermediate termination for via(s) of the first type of conductive extension, and additionally second via parts of a second type of conductive extension 572 and the corresponding second metal layer 522 part acting as termination for via(s) of the second type of conductive extension.

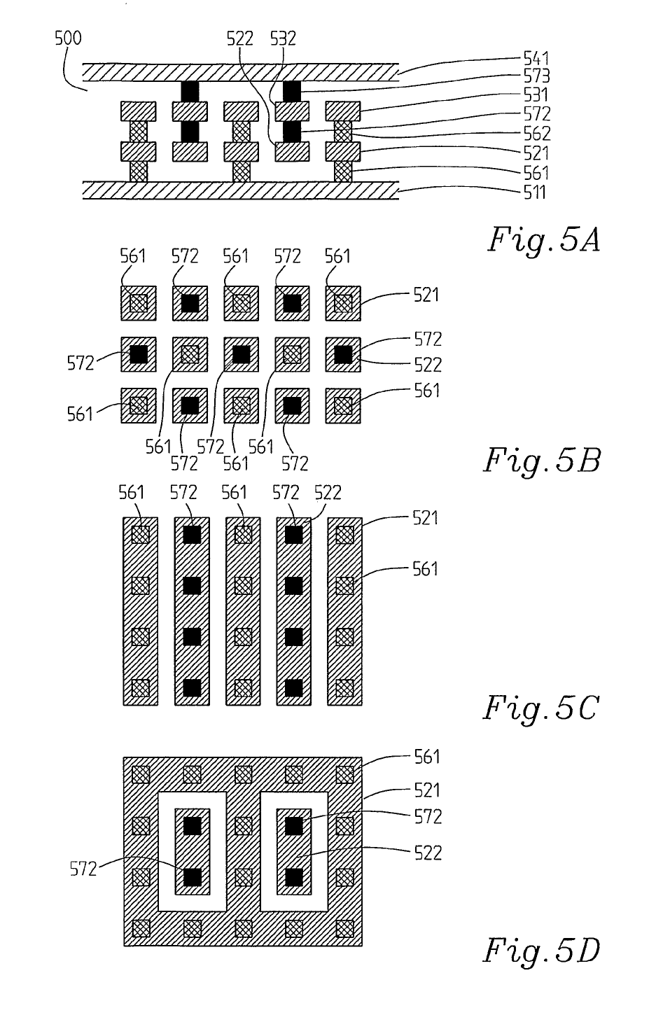

FIGS. 6A and 6B illustrate further cross section views of different layout examples of the conductive extensions where as previously first via parts of a first type of conductive extension 661, the corresponding second metal layer 621 part acting as intermediate termination for via(s) of the first type of conductive extension are shown, and additionally second via parts of a second type of conductive extension 672 and the corresponding second metal layer 622 part acting as termination for via(s) of the second type of conductive extension are shown.

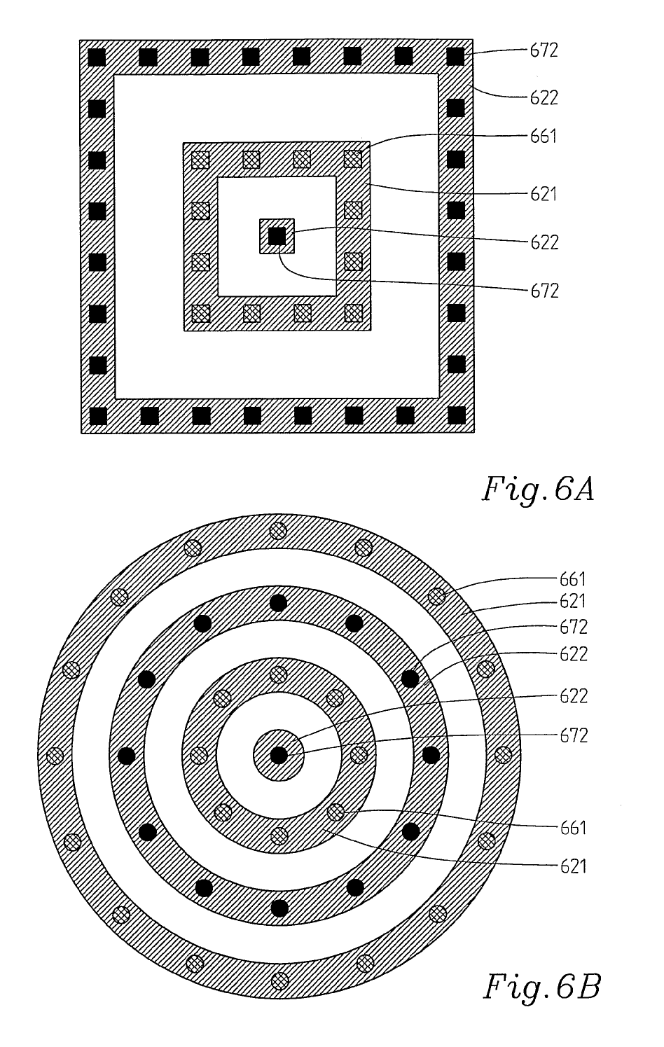

According to the invention, parts of the structure can be used to make other passive elements and active elements. FIGS. 7A and 7B illustrate an example of a resonant circuit in a structure according to the invention. Basically a RL segment 781 is added to the second metal layer that is connected to a first metal layer 711 by means of a first via 761. The RL segment 781 is also connected to a fourth metal layer 741 through a first via 773, part of the third metal layer 731 and a second via 772. Other parts of the second 722 and third 732 metal layer form terminations or intermediate terminations for vias to form conductive extensions of the first and second type.

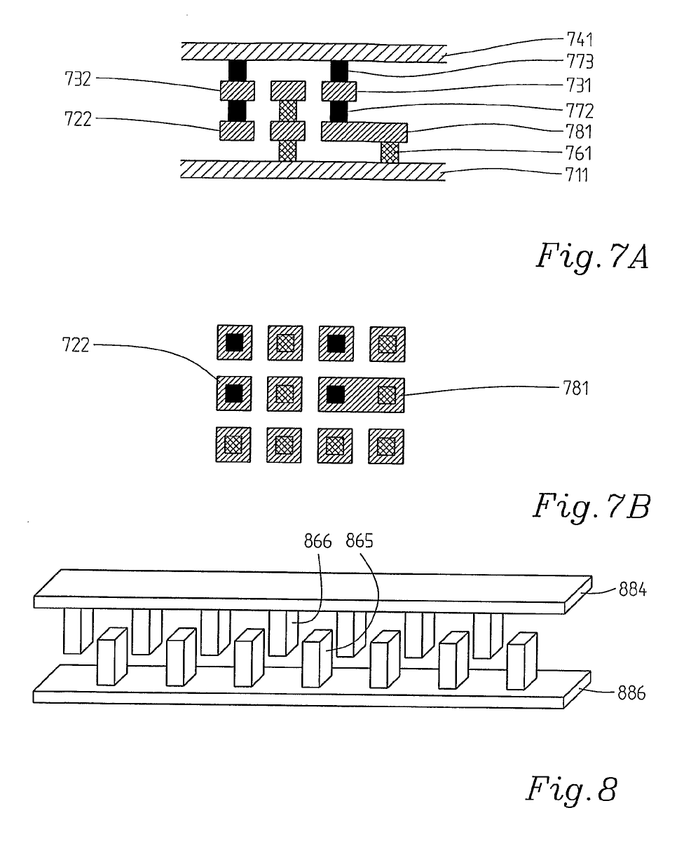

The capacitive structure according to the invention can advantageously be used in transmission lines due to its capability to be distributed. The characteristic impedance, i.e. the per unit length impedance, of a transmission line is directly proportional to the characteristic inductance and inversely proportional to the characteristic capacitance. This means that an increase in the characteristic inductance will increase the characteristic impedance, and that an increase in the characteristic capacitance will decrease the characteristic impedance. The electrical length is directly proportional to the characteristic inductance and directly proportional to the characteristic capacitance. This means that an increase in the characteristic inductance will increase the electrical length, and that an increase in the characteristic capacitance will also increase the electrical length. An ability to further control a transmission line's characteristic capacitance is thus a powerful tool in forming a transmission line with specific characteristics. FIG. 8 illustrates a transmission line structure according to the invention with first conductive extensions 865 placed at least substantially evenly along a first metal strip 886 and second conductive extensions 866 placed at least substantially evenly along a second metal strip 884. There being a distributed capacitive coupling between the first 865 and second 866 conductive extensions. The characteristic capacitance of the transmission line can thus be increased/controlled.

As a summary, the invention can basically be described as a method, which provides an efficient on-chip capacitor. This is accomplished by creating conductive extensions that extend at least substantially perpendicular from at least two metal layer planes and overlap with dielectric in between thus creating a capacitive coupling between them. The invention is not limited to the embodiments described above but may be varied within the scope of the appended patent claims.

FIG. 1A illustrates an example of a plate capacitor,

100 dielectric,

110 first plate,

120 second plate,

150 distance between first and second plate.

FIG. 1B illustrates a MIM (Metal-Insulator-Metal) integrated plate capacitor,

100 dielectric,

105 silicon wafer,

110 first ordinary metal layer,

121 first part of second ordinary metal layer,

122 second part of second ordinary metal layer,

161 via(s) between first part of second ordinary metal layer and first special thin metal plate,

162 via(s) between second part of second ordinary metal layer and second special thin metal plate,

171 first special thin metal plate,

172 second special thin metal plate.

FIG. 1C illustrates a MIMIM (Metal-Insulator-Metal-Insulator-Metal) integrated plate capacitor,

100 dielectric,

105 silicon wafer,

111 first part of first metal layer,

112 second part of first metal layer,

121 first part of second metal layer,

122 second part of second metal layer,

131 first part of third metal layer,

132 second part of third metal layer,

FIG. 2 illustrates a top view of an interdigitated capacitor layout,

211 first part of metal layer,

212 second part of metal layer.

FIG. 3A illustrates a side view of a basic embodiment of a capacitor structure according to the invention,

300 dielectric,

310 first metal layer, first conducting point in a first plane,

320 second metal layer, second conducting point in a second plane,

352 distance between first and second conducting extensions,

354 overlap distance of first and second conducting extensions,

365 first conducting extension from first conducting point towards second plane,

366 second conducting extension form second conducting point towards first plane.

FIG. 3B illustrates a side view of a preferred basic embodiment of a capacitor structure according to the invention,

300 dielectric,

315 first metal layer, a first conducting plate in first plane,

325 second metal layer, a second conducting plate in a second plane,

365 first conducting extension from first conducting point towards second plane,

366 second conducting extension form second conducting point towards first plane,

391 capacitive coupling between first and second conducting plates,

393 capacitive coupling between second conducting extension and first conducting plate,

394 capacitive coupling between first and second conducting extensions,

395 capacitive coupling between first conducting extension and second conducting plate.

FIG. 3C illustrates a cross section view across A-A of FIG. 3B of a capacitor structure according to the invention,

315 first conducting plate,

365 cross section of first conducting extension,

366 cross section of second conducting extension.

FIG. 3D illustrates a three-dimensional view of a preferred basic embodiment of a capacitor structure according to the invention,

315 first conducting plate,

325 second conducting plate,

365 first conducting extension,

366 second conducting extension.

FIG. 3E illustrates a cross section view of an alternative form of the conductive extensions,

315 first conducting plate,

365 cross section of alternative form of first conducting extension,

366 cross section of alternative form of second conducting extension.

FIG. 4A illustrates a side view of a preferred basic capacitor structure according to the invention in a three metal layer chip structure,

400 dielectric,

416 first metal layer, and a first conducting plate,

426 part of second metal layer, termination of via(s) from first metal layer/first conducting plate,

427 part of second metal layer, termination of via(s) from third metal layer/second conducting plate,

436 third metal layer, and a second conducting plate,

465 part of first conducting extension, a via between first and second metal layers,

466 part of second conducting extension, a via between second and third metal layers,

491 capacitive coupling between first and second conducting plates,

493 capacitive coupling between second metal layer of second conducting extension and first conducting plate,

494 capacitive coupling between first and second conductive extensions in the overlap area, in this example in the second metal layer where the vias of the first and second conductive extensions are terminated,

495 capacitive coupling between second metal layer of first conducting extension and second conducting plate,

FIG. 4B illustrates a cross section view along the middle metal layer of FIG. 4A,

426 second metal layer part of first conductive extension,

427 second metal layer part of second conductive extension,

465 via part of first conductive extension,

466 via part of second conductive extension.

FIG. 4C illustrates a side view of a capacitor structure according to the invention in a four metal layer chip structure,

400 dielectric,

418 first metal layer, first conductive plate,

428 second metal layer, intermediate termination for via(s) of first conductive extension,

429 second metal layer, termination for via(s) of second conductive extension,

438 third metal layer, termination for via of first conductive extension,

439 third metal layer, intermediate termination for via of second conductive extension,

448 fourth metal layer, second conductive plate,

465 first via part of first conductive extension,

466 first via part of second conductive extension,

467 second via part of first conductive extension,

468 second via part of second conductive extension.

FIG. 5A illustrates a side view of a more complex capacitor structure according to the invention in a four metal layer chip structure,

500 dielectric,

511 first metal layer, first conductive plate,

521 second metal layer, intermediate termination for via(s) of first conductive extension,

522 second metal layer, termination for via(s) of second conductive extension,

531 third metal layer, termination for via(s) of first conductive extension,

532 third metal layer, intermediate termination for via(s) of second conductive extension,

541 fourth metal layer, second conductive plate,

561 first via part of first conductive extension,

562 second via part of first conductive extension,

572 second via part of second conductive extension,

573 first via part of second conductive extension.

FIG. 5B-5D illustrate cross section views along one of the middle metal layers of FIG. 5A showing different layout examples of the conductive extensions,

521 second metal layer, intermediate termination for via(s) of first conductive extension,

522 second metal layer, termination for via(s) of second conductive extension,

561 first via part of first conductive extension,

572 second via part of second conductive extension.

FIG. 6A-6B illustrate further cross section views of different layout examples of the conductive extensions,

621 second metal layer, intermediate termination for via(s) of first conductive extension,

622 second metal layer, termination for via(s) of second conductive extension,

661 first via part of first conductive extension,

672 second via part of second conductive extension.

FIG. 7A-7B illustrate an example of a resonant circuit in a structure according to the invention,

711 first metal layer/first conductive plate,

722 second metal layer, termination for via(s) of conductive extensions from fourth metal layer/second conductive plate,

731 third metal layer, intermediate termination for conductive extension to RL,

732 third metal layer, intermediate termination for via(s) of conductive extensions from fourth metal layer/second conductive plate,

741 fourth metal layer/second conductive plate,

761 first via part from first metal layer to RL of second metal layer,

772 second via part from fourth metal layer via third metal layer to RL of second metal layer,

773 first via part from fourth metal layer,

781 RL segment of second metal layer.

FIG. 8 illustrates a transmission line structure according to the invention,

865 first conductive extension(s) from first metal strip,

866 second conductive extension(s) from second metal strip,

884 second metal strip,

886 first metal strip.

1-29. (canceled)

30. A method of arranging an on-chip capacitor on a chip to create a capacitance between a first conducting connection point in a first plane of the chip and a second conducting connection point in a second plane of the chip, comprising the steps of:
creating at least one conducting extension of a first type from the first conducting connection point toward the second plane to a third plane, and
creating at least one conducting extension of a second type from the second conducting connection point toward the first plane to a fourth plane,
wherein the fourth plane is located between the first plane and the second plane, the third plane is located between the fourth plane and the second plane, and the conducting extension of the first type is isolated from the conducting extension of the second type by a dielectric allowing an electric field to be created between the conducting extensions.

31. The method of claim 30, wherein a plurality of conducting extensions of the first type are created.

32. The method of claim 30, wherein a plurality of conducting extensions of the second type are created.

33. The method of claim 30, wherein the first plane is a side of a first metal layer, the second plane is a side of a second metal layer, and the first and second metal layers are different metal layers.

34. The method of claim 33, wherein the third and fourth planes are different sides of a third metal layer.

35. The method of claim 33, wherein the third plane is a side of a third metal layer, the fourth plane is a side of a fourth metal layer, and the third and fourth metal layers are different metal layers.

36. The method of claim 30, wherein the at least one conducting extension of the first type originates in a metal layer and terminates in a metal layer.

37. The method of claim 36, wherein the at least one conducting extension of the first type extends through at least one further metal layer.

38. The method of claim 30, wherein the at least one conducting extension of the second type originates in a metal layer and terminates in a metal layer.

39. The method of claim 38, wherein the at least one conducting extension of the second type extends through at least one further metal layer.

40. The method of claim 30, further comprising the step of extending the first conducting connection point in the first plane of the chip such that the first conducting connection point comprises a conducting plate.

41. The method of claim 30, further comprising the step of extending the second conducting connection point in the second plane of the chip such that the second conducting connection point comprises a conducting plate.

42. The method of claim 30, further comprising the step of arranging one or more on-chip capacitors with at least one other passive component into an on-chip resonant circuit.

43. The method of claim 30, further comprising the step of arranging one or more on-chip capacitors into an on-chip transmission line.

44. An on-chip capacitor with a capacitance between a first conducting connection point in a first plane of a chip and a second conducting connection point in a second plane of the chip, the on-chip capacitor comprising:
at least one conducting extension of a first type extending from the first conducting connection point toward the second plane to a third plane, and
at least one conducting extension of a second type extending from the second conducting connection point toward the first plane to a fourth plane,
wherein the fourth plane is located between the first plane and the second plane, the third plane is located between the fourth plane and the second plane, and the conducting extension of the first type is isolated from the conducting extension of the second type by a dielectric allowing an electrical field to be created between the extensions.

45. The on-chip capacitor of claim 44, wherein the on-chip capacitor comprises a plurality of conducting extensions of the first type.

46. The on-chip capacitor of claim 44, wherein the on-chip capacitor comprises a plurality of conducting extensions of the second type.

47. The on-chip capacitor of claim 44, wherein the first plane is a side of a first metal layer, the second plane is a side of a second metal layer, and the first and second metal layers are different metal layers.

48. The on-chip capacitor of claim 47, wherein the third and fourth planes are different sides of a third metal layer.

49. The on-chip capacitor of claim 47, wherein the third plane is a side of a third metal layer, the fourth plane is a side of a fourth metal layer, and the third and the fourth metal layers are different metal layers.

50. The on-chip capacitor of claim 44, wherein the at least one conducting extension of the first type originates in a metal layer and terminates in a metal layer.

51. The on-chip capacitor of claim 50, wherein the at least one conducting extension of the first type extends through at least one further metal layer.

52. The on-chip capacitor of claim 44, wherein the at least one conducting extension of the second type originates in a metal layer and terminates in a metal layer.

53. The on-chip capacitor of claim 52, wherein the at least one conducting extension of the second type extends through at least one further metal layer.

54. The on-chip capacitor of claim 44, wherein the first conducting connection point in the first plane of the chip comprises a conducting plate.

55. The on-chip capacitor of claim 44, wherein the second conducting connection point in the second plane of the chip comprises a conducting plate.

56. The on-chip capacitor of claim 44, wherein the on-chip capacitor is included in a resonant circuit.

57. An on-chip transmission line, wherein the transmission line comprises at least one on-chip capacitor defined by claim 44.

58. The on-chip transmission line of claim 57, wherein the on-chip transmission line is included in a resonator, matching network, or power splitter.
